(19) United States
(12) Patent Application Publication
(10) Pub. No.: US 2015/0360295 A1
(43) Pub. Date: Dec. 17, 2015

(54) TOOL HOLDER FOR A TOOL WITH A TOOL SHAFT PROVIDED WITH AN OUTER THREAD

(71) Applicant: FRANZ HAIMER MASCHINENBAU KG, Igenhausen (DE)

(72) Inventor: Andreas HAIMER, Igenhausen (DE)

(21) Appl. No.: 14/764,471

(22) PCT Filed: Jan. 30, 2014
(86) PCT No.: PCT/EP2014/051777

§ 371 Date: Jul. 29, 2015

(30) Foreign Application Priority Data
Jan. 30, 2013 (DE) 10 2013 100 939.5

(51) Int. Cl. B23B 31/11; B23C 5/28; B23C 5/10

(52) U.S. Cl. CPC B23B 31/1115; B23C 5/1009; B23C 5/28; B23B 2231/24; B23C 2240/32

(57) ABSTRACT

A tool holder for a screw-in tool, having a receiving body, which includes a receiving opening with an inner thread and a support region with at least one guide surface for receiving the screw-in tool in the tool holder accurately in position. The receiving body has a receiving part and a guide part, which is fixed on the receiving part and on which the support region with the at least one guide surface is provided.

The invention concerns a tool holder for a screw-in tool and a tool arrangement with such a tool holder.

A tool arrangement with a screw-in tool and a tool holder for the screw-in tool is known from WO 2006/033617 A1. The tool holder consists of a one-part, hollow-cylindrical main body, in which a receiving opening with an inner thread is provided. Guide surfaces that ensure a centric, accurately positioned receiving of the screw-in tool are provided in the main body.

With such tool holders, however, there is the danger that the guide surfaces are damaged or subjected to wear during the change or replacement of the screw-in tools, wherein the precision is impaired. Then, under certain circumstances, the entire tool holder has to be replaced.

The goal of the invention is to create a tool holder of the type mentioned in the beginning and a tool arrangement with such a tool holder that make possible an accurately positioned and reproducible receiving and mounting of a screw-in tool with a longer utilization.

This goal is attained by a tool holder with the features of claim 1 and by a tool arrangement with the features of claim 17. Appropriate refinements and advantageous embodiments of the invention are the objects of the subclaims.

In the tool holder in accordance with the invention, the receiving body is formed by a receiving part and a guide part that is fixed on the receiving part, on which a support region with at least one guide surface is provided. By means of the guide part, a reinforcement of the receiving part can be attained. Furthermore, due to the two-part structure of the receiving body, micro-sliding can occur between the receiving part and the guide part, wherein vibrations can be damped or absorbed.

The guide part, which ensures the accurately positioned receiving of the screw-in tool in the tool holder, can be fixed in a detachable manner on the receiving part in a preferred embodiment, so that, if needed, it can be easily replaced. Even with damage to the guide part, the tool holder can continue to be used after an easy replacement of the guide part.

The receiving part is preferably made of hard metal or another brittle and hard material, whereas the replaceable guide part is made of steel or another tough material. In this way, the tool holder can be constructed such that it is rigid and, in the area of the guide, is nevertheless not sensitive to impacts. Due to the greater elasticity of the guide part, vibrations can be damped and inaccuracies can be better compensated for. Furthermore, the screw-in tool can be screwed into the tool holder with a greater tightening force, wherein the accuracy can be improved. The receiving part, however, can also be made of a heavy metal, different alloys with a vibration-damping behavior, or a plastic, in particular, a fiber composite.

In a particularly appropriate embodiment, the support region on the guide part is formed by a first and second guide surface. In this way, a double guide and more accurate positioning of the screw-in tool in the tool holder is made possible. The second guide surface need not thereby necessarily be placed on the guide part. The second guide surface can also be a component of the receiving part.

The first guide surface and the second guide surface can be appropriately formed as conical surfaces with different cone angles. In this way, a support region with a double cone is created, which, in comparison to a flat face or a straight contact surface, makes possible an enlarged contact surface and an improved centering and supporting effect. For the radial and axial positioning, the two guide surfaces can also run parallel or perpendicular to the longitudinal axis of the guide part.

The first guide surface on the guide part, adjacent to the tool head of the screw-in tool, and the corresponding first contact surface of the screw-in tool preferably have a relatively large cone angle between 140° and 179°. Here, a cone angle of 170° has proved to be favorable. The second guide surface on the guide part and the corresponding second contact surface on the screw-in tool preferably have relatively small cone angles between 90° and 1°. Here, a cone angle of 10° has proved to be favorable. A double cone of the described type has the advantage that the small cone angle makes possible a good centering of the screw-in tool with greatly reduced spreading forces on the tool holder, and the large cone angle makes possible an additional centering. The cone angle is understood to be the opening angle of the cone formed by the conical guide surfaces.

The guide part can be appropriately pressed or shrunk on the receiving part, or it can be connected with it via a threaded connection. In this way, the guide part is securely held on the receiving part, but it can be easily replaced when necessary. The guide part and the receiving part, however, can also be connected detachably in another suitable manner or they can be firmly connected with one another. The guide part can be made as a single part or in several parts. In a two-part embodiment, the guide part can, for example, be made out of a tough material in a front receiving region, preferably steel, and in a rear region, out of another material, for example, a fiber composite.

The guide part can be stuck on a cylindrical section on the front end of the receiving part, and can have gradation with a rear contact surface for the contact on a front surface of the receiving part. The guide part, however, can also be connected with the receiving part via a conical connection.

The inner thread is preferably located in the rear receiving part and can be formed as a conical inner thread. The inner thread, however, can also be made as a cylindrical inner thread.

The invention also concerns a tool arrangement with a screw-in tool and a tool holder described in the preceding. The screw-in tool appropriately has at least one contact surface for the contact on the at least one guide surface on the front guide part of the tool holder.

In another advantageous manner, on the inner end of the receiving opening of the tool holder and correspondingly on the rear end of the tool shaft, there is another support region with an inner contact surface for the contact of a support surface on the rear end of the tool shaft. The support surface on the rear end of the tool shaft can be made, for example, spherical, whereas the corresponding additional support region on the tool holder can be made as a cylindrical support surface. By means of the spherical contact region and the cylindrical support surface, an only partial contact is attained between the screw-in tool and the tool holder in this region. Appropriately, the tool shaft has an excess, in comparison to the cylindrical contact surface, in the region of the support surface, so that the pretension in this second support region is independent of the screw-in depth. However, other developments of the additional support region are also conceivable. Thus, spherical, conical, or cylindrical contact surfaces or support surfaces can also be provided in any combination on the tool and the tool holder.

For the outer thread and the corresponding inner thread, trapezoidal threads or flat threads have proved to be particularly appropriate. However, the threads can also be formed as cone threads, round threads, buttress threads, or the like.

In order to simplify the production of the screw-in tool, a gripper groove can be provided on the tool shaft to clamp in the screw-in tool. Pincer-shaped gripper elements of a clamping device, for example, can be engaged in order to clamp the tool in the tool holder. In clamping with the aid of the gripper groove, the tool and the tool holder can be provided with an anti-twist device.

Other features and advantages of the invention can be deduced from the following description of preferred embodiment examples with the aid of the drawings. The figures show the following:

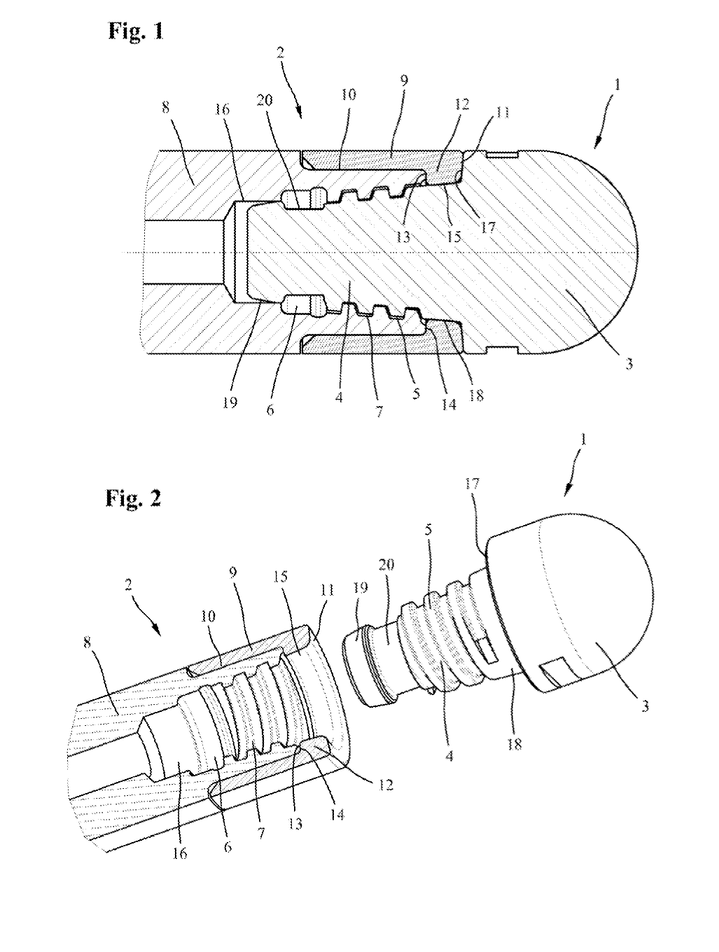

FIG. 1, a tool holder and a screw-in tool in a longitudinal section;

FIG. 2, the tool holder and the screw-in tool of FIG. 1 in a perspective view;

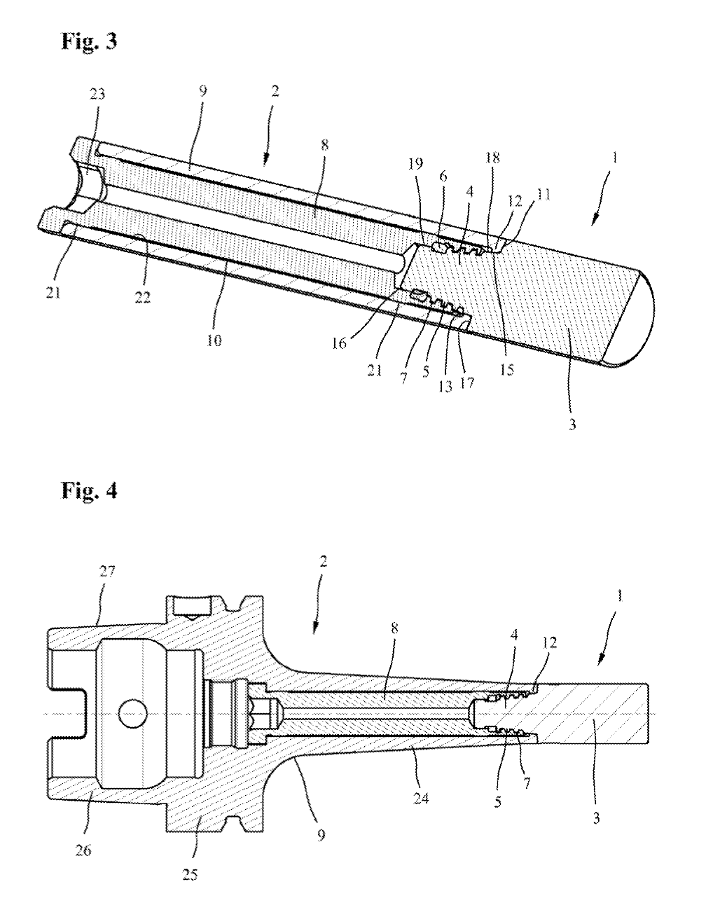

FIG. 3, a second embodiment example of a tool holder with a screw-in tool in a sectional view;

FIG. 4, a third embodiment example of a tool holder with a screw-in tool in a sectional view; and

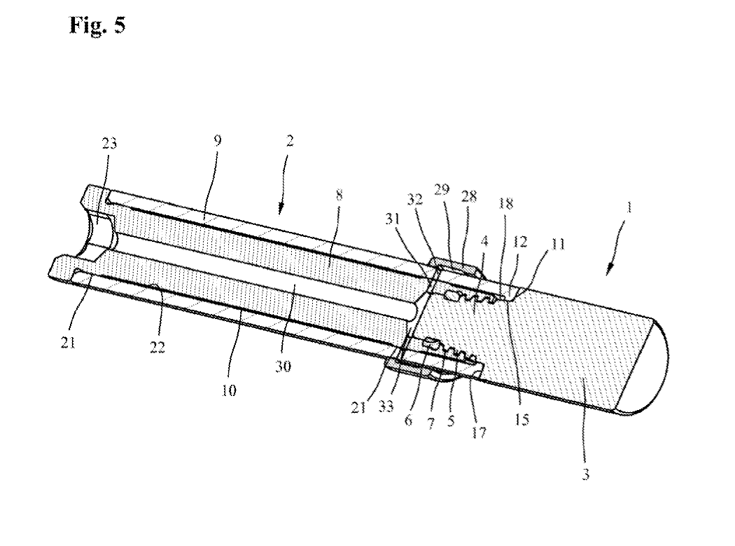

FIG. 5, a fourth embodiment example of a tool holder with a screw-in tool in a sectional view.

FIGS. 1 and 2 show a tool arrangement with a screw-in tool 1 and a corresponding tool holder 2 in a longitudinal view and a perspective view. The screw-in tool 1 has a tool head 3, designed here as a spherical head milling cutter, and a tool shaft 4 with an outer thread 5. The tool holder 2 belonging to the screw-in tool 1 contains a receiving body, in which a receiving opening 6 with an inner thread 7 is provided. For the screwing in of the screw-in tool 1, the inner thread 7 is adapted to its outer thread 5.

The receiving body of the tool holder 2 comprises a hollow-cylindrical, rear receiving part 8 and a front guide part 9, which is fixed, in a detachable manner, on the receiving part 8. The inner thread 7 is located in the rear receiving part 8. The sleeve-shaped, front guide part 9 can be pressed or shrunk, for example, onto the rear receiving part 8. The rear receiving part 8 is preferably made of hard metal, whereas the sleeve-shaped, front guide part 9 is preferably made of steel. For the accurately positioned receiving of the screw-in tool 1, the guide part 9, placed on the cylindrical section 10 on the front end of the receiving part 8, has a first guide surface 11 on its front side. The guide part 9 also contains a gradation 12 on the front end, on which a rear contact surface 13 is provided for the contact on a front surface 14 of the receiving part 8, and on which a second guide surface 15 is provided for the guidance of the screw-in tool 1.

In the embodiment example shown in the drawing, the receiving opening 6 of the tool holder 2 contains a front region tapering conically inward, with the likewise conical, inner thread 7 and a cylindrical, inner region with a cylindrical, inner contact surface 16.

In the embodiment shown, the tool shaft 4 of the screw-in tool 1 runs conically toward the rear and the outer thread 5 is also made conical. Between the tool head 3 and the outer thread 5, there is a first support region with a first contact surface 17 for the contact on the first guide surface 11 of the guide part 9 and a second contact surface 18 for the contact on the second guide surface in the interior of the guide part 9. The first and second guide surfaces 11 and 15 on the guide part 9 and the corresponding contact surfaces 17 and 18 on the screw-in tool 1 are preferably made as conical surfaces with different conical angles. In this way, a support region with a double cone is created, which makes possible an enlarged support surface and an improved centering and supporting effect, in comparison to a flat face or a straight contact surface.

In the embodiment shown in FIGS. 1 and 2, the screw-in tool 1 has a conical angle of 170° on the first contact surface 17 and a conical angle of 10° on the second contact surface 18. The corresponding guide surfaces 11 and 15 on the guide part 11 [sic; possibly 9] have corresponding angles. A double cone of the described type has the advantage that the small conical angle makes possible a good centering of the screw-in tool in the tool holder and the large conical angle makes possible an additional centering, but with greatly reduced spreading forces on the tool holder. In addition, by means of the conical first contact surface, the rigidity of the tool is increased, since the tool cannot slide off with a radial load, as is the case with a planar contact surface. The outer thread 5 on the screw-in tool 1 and the corresponding inner thread 7 on the tool holder 2 are made as trapezoidal threads with different flank angles. The outer thread 5 and the inner thread 7, however, can also have another thread form.

On the inner end of the receiving opening 6, there is another support region with the cylindrical contact surface 16, on which a spherical or rounded-off outer support surface 19 comes to a stop on the rear end of the tool shaft 4. By means of the additional support region of the screw-in tool 1, an additional guidance of the screw-in tool 1 within the tool holder 2 is attained. The spherical or rounded-off supporting surface 19 ensures a partial contact between the screw-in tool 1 and the tool holder 2 in this region. Appropriately, the tool shaft 4 in the region of the support surface 19 has an excess, in comparison to the cylindrical contact surface 16, so that the pretension in this second support region is independent of the screwing-in depth.

In order to simplify the production of the screw-in tool, a gripper groove 20 for the clamping of the screw-in tool can be provided on the tool shaft 4. Pincer-shaped gripper elements of a clamping device for the clamping of the tool, for example, can engage in the gripper groove.

FIG. 3 shows another embodiment example of a tool arrangement with a screw-in tool 1 and a corresponding tool holder 2. Here, the screw-in tool 1 has a cylindrical tool head 3 and a tool shaft 4 with an outer thread 5. The tool holder 2 belonging to the screw-in tool 1 contains a receiving body, which comprises a hollow-cylindrical receiving part 8, designed here as a thread insert, and a sleeve-shaped guide part 9, which is fixed in a detachable manner on the receiving part 8. The hollow-cylindrical receiving part 8 contains a cylindrical section 10 with two support regions 21, which are at a distance from one another in the axial direction and which, in the embodiment shown, are designed as outer thread sections. Above these, the sleeve-shaped guide part 9, provided with a first inner thread 22, is screwed on and supported on the cylindrical section 10. The support regions 21, which, in the embodiment shown, are located in the front and rear parts of the cylindrical section 10, can also be freely distributed over the length of the section 10. The support regions 21 are located in a closed annular manner around the receiving part in the drawing, but can also be made as segments or the like. The receiving part 8 has the receiving opening 6 with the inner thread 7 on the one end and an inner hexagonal 23 on the other end. The receiving part 8, designed as a thread insert, can be made of heavy or hard metal, of different alloys with vibration-damping behavior, and of plastics, in particular fiber composites.

For the accurately positioned receiving of the screw-in tool 1, the guide part 9 in this embodiment also has a first guide surface 11 on its front side. The guide part 9 also contains a gradation 12 on the front end, on which a second inner guide surface 15 is provided for the guidance of the screw-in tool 1.

As in the embodiment of FIGS. 1 and 2, the receiving opening 6 of the tool holder 2 contains, in the embodiment shown in FIG. 3, a front region which tapers conically inward, with the likewise conical inner thread 7 and a cylindrical inner region, with a cylindrical inner contact surface 16, on which a spherical or rounded-off outer support surface 19 comes to a stop on the rear end of the tool shaft 4.

In the embodiment of FIG. 3, the tool shaft 4 of the screw-in tool 1 also runs conically to the rear and the outer thread 5 is likewise made conical. Between the tool head 3 and the outer thread 5, there is a first support region with a first contact surface 17 for the contact on the first guide surface 11 of the guide part 9 and a second contact surface 18 for the contact on the second guide surface in the interior of the guide part 9. The first and second guide surfaces 11 and 15 on the guide part 9 and the corresponding contact surfaces 17 and 18 on the screw-in tool 1 are preferably made as conical surfaces with different conical angles. In this way, a support region with a double cone is created, which makes possible an enlarged support surface and an improved centering and supporting effect, in comparison to a flat face or a straight contact surface.

The embodiment example shown in FIG. 4 differs from the embodiment in accordance with FIG. 3 merely in that the guide part 9 is designed in the form of a tool holder body, provided with an interface for the receiving in a work spindle of a tool machine. In the embodiment shown, the guide part 9 is made, for example, as an HSK tool holder body with a conical front receiving region 24, a cylindrical intermediate region 25, and a conical rear receiving region 26 with a conical outer clamping surface 27 for the receiving in a work spindle of a tool machine. The guide part 9, however, can also be designed in two parts or consist of more than two parts. Thus, for example, the guide part 9 in the front receiving region (that is, the region with or around the thread) can be made of a tough material, preferably steel, and in the rear region, of any other material, for example, a fiber composite, such as CFK. Instead of the HSK interface, SK, JIS, BT, ABS, capto-, or other suitable interfaces can also be provided on the tool holder body. The hollow-cylindrical receiving part 8, designed as a thread insert, corresponds to the embodiment of FIG. 3 and is screwed with the guide part 9, designed here as a tool holder body.

FIG. 5 shows another embodiment example of a tool arrangement, which essentially corresponds to the embodiment of FIG. 3. In contrast to the embodiment of FIG. 3, a sleeve 28 with an inner cooling agent channel 29 is located on the outside of the guide part 9 to guide a cooling agent to the outside of the tool 1. The cooling agent channel 29 is closed on the rear side and open on the front side, turned toward the tool 1, and designed in such a way that a cooling agent that is introduced into the cooling agent channel 29 of the sleeve 28 can be conducted to the interface between the workpiece and the tool. To introduce a cooling agent into the cooling agent channel 29, there are, in the receiving part 8, first transverse boreholes 31 branching off from a central supply channel 30 and leading to the outside of the receiving part 8, and, in the guide part 9, second transverse boreholes 32, aligned with the first transverse boreholes 31 and discharging into the cooling agent channel 29 of the sleeve 28. In the embodiment shown, two diametrically opposing transverse boreholes 31 and 32 are provided. Of course, however, it is possible also for one or more than two transverse boreholes 31 and 32 to be present, distributed over the circumference. Otherwise, this embodiment is structured in accordance with the embodiment of FIG. 3, wherein components corresponding to one another are provided with the same reference symbols and, with regard to their explanation, reference is made to the description for FIG. 3.

In the embodiment shown in FIG. 5, the central supply channel 30 is constructed in the receiving part 8 as a passage channel, which ends in a distribution space 33 at the end of the receiving opening 6. In this way, the cooling agent can also go up to the screw-in region of the tool. This is either closed by the shaft of the screwed-in tool or the cooling agent can flow to its tool head by means of additional cooling boreholes in the tool. The supply channel 30, however, need not extend to the screw-in region. It can also have already ended in the transverse boreholes 31 which lie further to the rear and which then have no connection to the screw-in region. This can prevent a cooling or lubricating agent from flowing to the screw-in region.

The invention is not limited to the embodiment examples described in the preceding and depicted in the drawing. Thus, for example, an insert sleeve can also be provided in the tool holder. This insert sleeve can then contain the thread or also guide surfaces. By the selection of a suitable material for the insert sleeve, a vibration damping can be attained. Moreover, the tool holder can be adapted, by various insert sleeves, for the receiving of different tool configurations. The insert sleeve can consist of one part or of several parts, which can also be made of different materials.

1-21. (canceled)

22. Tool holder for a screw-in tool with a receiving body, which contains a receiving opening with an inner thread and a support region having a first guide surface and a second guide surface for the accurately positioned receiving of the screw-in tool in the tool holder, wherein the receiving body contains a receiving part and a guide part, fixed on the receiving part, on which the support region is provided, wherein the guide part contains a gradation, which has at least the second guide surface, and the inner thread is located in the receiving part.

23. Tool holder according to claim 22, wherein the guide part is fixed in a detachable manner on the receiving part.

24. Tool holder according to claim 22, wherein the receiving part is made of hard metal, of heavy metal, of different alloys with a vibration-damping behavior, or of a plastic, in particular a fiber composite.

25. Tool holder according to claim 22, wherein the guide part is formed as a single part or has several parts.

26. Tool holder according to claim 22, wherein the guide part is made, at least partially, of steel.

27. Tool holder according to claim 22, wherein the first guide surface and the second guide surface are designed as conical surfaces with different cone angles.

28. Tool holder according to claim 27, wherein the first guide surface has a cone angle between 140° and 179° and the second guide surface has a cone angle between 90° and 1°.

29. Tool holder according to claim 22, wherein the guide part is pressed or shrunk onto the receiving part, or is connected with it by a thread connection.

30. Tool holder according to claim 22, wherein the guide part contains a gradation with a rear contact surface for the contact on a front surface of the receiving part.

31. Tool holder according to claim 22, wherein the inner thread is located in the receiving part.

32. Tool holder according to claim 22, wherein the inner thread is designed as a conical inner thread.

33. Tool holder according to claim 22, wherein another support region is provided with an inner contact surface for the screw-in tool on the inner end of the receiving opening.

34. Tool holder according to claim 22, wherein the guide part is designed in the form of a tool holder body provided with an interface for the receiving in a work spindle of a tool machine.

35. Tool holder according to claim 22, wherein a sleeve with an inner cooling agent channel is located on the outside of the guide part to guide a cooling agent to the outside of the tool.

36. Tool holder according to claim 35, wherein, in the receiving part, there are first transverse boreholes, branching off from a central supply channel and leading to the outside of the receiving part, and, in the guide part, there are second transverse boreholes, aligned with the first transverse boreholes and discharging into the cooling agent channel of the sleeve.

37. Tool arrangement with a screw-in tool and a tool holder, wherein the tool holder is the tool holder of claim 22.

38. Tool arrangement according to claim 37, wherein the screw-in tool contains at least one contact surface for the contact on the at least one guide surface on the front guide part of the tool holder.

39. Tool arrangement according to claim 37, wherein the screw-in tool contains a tool shaft with an outer thread that corresponds to the inner thread of the tool holder.

40. Tool arrangement according to claim 39, wherein a support surface is provided on the inner end of the tool shaft.

41. Tool arrangement according to claim 40, wherein a gripper groove is located on the tool shaft of the screw-in tool.
